(19) United States
(12) Patent Application Publication
(10) Pub. No.: US 2016/0246455 A1
(43) Pub. Date: Aug. 25, 2016

(54) METHOD FOR VIRTUALLY EXPERIENCING REAL LIFE AND ACQUIRING INFORMATION USING APP OF MOBILE COMMUNICATION TERMINAL

(71) Applicant: Min young CHOI, Ulsan (KR)

(72) Inventor: Min Young CHOI, Ulsan (KR)

(21) Appl. No.: 15/023,951

(22) PCT Filed: Sep. 1, 2014
(86) PCT No.: PCT/KR2014/008113

§ 371 Date: Mar. 22, 2016

(30) Foreign Application Priority Data
Sep. 23, 2013 (KR) 10-2013-0112861

(51) Int. Cl. G06F 3/0482; G06F 3/0481; G06T 19/00; H04M 1/725

(52) U.S. Cl. CPC G06F 3/0482; H04M 1/72552; H04M 1/72583; G06F 3/04817; G06T 19/006; G06T 2200/24

(57) ABSTRACT

A system for controlling rolling of a vehicle and a method therefor, where the system comprises: a control unit for receiving and analyzing a steering signal and a driving signal from a driver of a vehicle having a frame by which the gradient of the vehicle during traveling can be controlled and generating a steering control signal and a driving control signal on the basis of a result value according to the analysis; and a steering unit and a driving unit for controlling a traveling direction and driving of the vehicle according to the steering control signal and the driving control signal received from the control unit, respectively.

### BACKGROUND

The present disclosure relates to a method for virtually experiencing a real life and acquiring information using an app of a mobile communication terminal, and in particular to a method for virtually experiencing a real life and acquiring information using an app of a mobile communication terminal wherein a space similar to a real life space can be virtually created in a program space using a 3D-based app.

Many of conventional smartphone apps used widely by many users are developed on the basis of a 2D program. The 2D-based apps may have a limit in developing various programs in the respect that most of 2D-based smartphone App-programs are developed as to providing the users with mere information and monotonous amusement so that they are not readily applied to a real life.

Moreover, many of small and medium sized enterprises have very limited opportunities to advertise their high-tech products to potential customers due to scarcity of resources.

For this reason, products backed with marketing funding resources could be more exposed to consumers along with their strong impression. Therefore, the consumers cannot have that many chances to experience the products manufactured by the less funded small and medium-sized enterprises.

To resolve such a problem, rather than using outdated 2D-apps, 3D-smartphone apps can be employed to offer more chances for manufacturers to expose their various products through consumers' virtual spaces so that most of small and mid-sized enterprises can have more cost-effective marketing chances through consumers' virtual experiences on the products.

### SUMMARY OF THE DISCLOSURE

The present invention has been made in an effort to solve the above-described problems associated with prior art.

It is an object of the present invention to provide a method for virtually experiencing a real life and acquiring information using an app of a mobile communication terminal wherein an individual or a lot of ordinary users using a corresponding program are able to previously experience a virtual reality, which cannot be readily and actually applied in a real life, based on shared information in such a way to virtually create in a program space a predetermined virtual space which is similar to an actual life space by using a 3D-based app.

To achieve the above objects, there is provided a method for virtually experiencing real life and acquiring information using an app of a mobile communication terminal, which may include, but is not limited to, a step wherein when a mobile communication terminal executes an app selected by a user's key operation, an image object of a virtual environment is displayed, wherein various product icons corresponding to an actual room environment are disposed at a basic position; a step wherein the mobile communication terminal selects a predetermined product icon in a virtual room based on a user's key operation; and a step wherein the mobile communication terminal is mapped by product icon with various function button display objects related with a corresponding product in order for a predetermined function of the mobile communication terminal to be executed when a corresponding function button is clicked, and the mobile communication terminal allows the various function button objects mapped with the selected product icon when the product icon is selected, to be displayed, and when the predetermined function button display object is selected, a predetermined function of the mobile communication terminal which has been set mapped with the corresponding function button is executed,

Preferably, if the selected product icon is a telephone number book, the mobile communication terminal carries out the method which may include, but is not limited to, a step wherein the display objects of a friend registration button related with the telephone number book, an invitation button, an invitation request button, a friend deletion button, and an exit button are displayed at the screen; a step wherein if the friend registration button is clicked, the friend names registered at the telephone number book of the mobile communication terminal are displayed, and a friend who the user wants to register can be clicked and registered; a step wherein if the invitation request button is clicked, an invitation is requested by clicking a desired friend based on a friend registration information in order to enter a friend's room, and an approval and rejection popup window is displayed at the screen of the opponent's mobile communication terminal in response to the invitation request, and if the opponent clicks the approval, the image object of the virtual room environment is displayed, and the screen returns back to the virtual room environment, and if the opponent clicks the rejection, the app is closed; a step wherein if the friend deletion button is clicked, a registered friend name is created and displayed, and if the friend who the user wants to delete is selected, the friend is deleted; and a step wherein if the exit button is clicked, the image object of the virtual room environment is displayed, and the screen returns back to the virtual room environment.

Moreover, if the selected product icon is a telephone, the mobile communication terminal carries out the method which may include, but is not limited to, a step wherein a text input window related with the telephone is displayed; a step wherein a notice icon with respect to the text inputted at the text input window is displayed at the screens of the mobile communication terminals of all persons in a room; a step wherein if the notice icon is clicked or the telephone in the room is clicked, the texts are displayed and confirmed, and the texts can be inputted by displaying the text input window; and a step wherein if an exit button is clicked, an image object of the virtual room environment is displayed, and the screen returns back to the virtual room environment.

Preferably, if the selected product icon is a television, the mobile communication terminal carries out the method which may include, but is not limited to, a step wherein an image list button related with the television, an image registration button, an image deletion button and an exit button display object are displayed; a step wherein if the image list button is clicked, the image list registered by a room owner is displayed at the screen, and if all the persons who have entered the room click the list, a video is displayed, and if a predetermined button is clicked, the image object of the virtual room environment is displayed, and the screen returns back to the virtual room environment; a step wherein if the image registration button is clicked, a video selected by the room owner among the videos stored in the mobile communication terminal is registered, and if a predetermined button is clicked, the image object of the virtual room environment is displayed, and the screen returns back to the virtual room environment; a step wherein if the image deletion button is clicked, a video that the room owner wants to delete is deleted based on the video registration information, and if a predetermined button is clicked, the image object of the virtual room environment is displayed, and the screen returns back to the virtual room environment; and a step wherein if the exit button is clicked, the image object of the virtual room environment is displayed, and the screen returns back to the virtual room environment.

Moreover, if the selected product icon is a frame, the mobile communication terminal carries out the method which may include, but is not limited to, a step wherein if the selected product icon is a frame, the mobile communication terminal displays a photo list button related with the frame, a photo registration button, a photo deletion button, and an exit button display object; a step wherein if the photo list button is clicked, the photo list registered by the room owner is displayed at the screen, and if all the persons who have entered the room click the list, the image is displayed, and if a predetermined button is clicked, the image object of the virtual room environment is displayed, and the screen returns back to the virtual room environment; a step wherein if the photo registration button is clicked, the photo selected by the room owner among the photos stored in the mobile communication terminal is registered, and if a predetermined button is clicked, the image object of the virtual room environment is displayed, and the screen returns back to the virtual room environment; a step wherein if the photo deletion button is clicked, the photo that the room owner wants to delete is deleted based on the photo registration information, and if a predetermined button is clicked, the image object of the virtual room environment is displayed, and the screen returns back to the virtual room environment; and a step wherein if the exit button is clicked, the image object of the virtual room environment is displayed, and the screen returns back to the virtual room environment.

Preferably, if the selected product icon is an audio system, the mobile communication terminal carries out the method which may include, but is not limited to, a step wherein a music list button related with the audio system, a music registration button, a music deletion button and an exit button display object are displayed; a step wherein if the music list button is clicked, the music list registered by the room owner is displayed at the screen, and if all the person who have entered the room click the list, the music is played, and if a predetermined button is clicked, the image object of the virtual room environment is displayed, and the screen returns back to the virtual room environment; a step wherein if the music registration button is clicked, the music selected by the room owner among the music stored in the mobile communication terminal is registered, and if a predetermined button is clicked, the image object of the virtual room environment is displayed, and the screen returns back to the virtual room environment; a step wherein if the music deletion button is clicked, the music that the room owner wants to delete is deleted based on the music registration information, and if a predetermined button is clicked, the image object of the virtual room environment is displayed, and the screen returns back to the virtual room environment; and a step wherein if the exit button is clicked, the image object of the virtual room environment is displayed, and the screen returns back to the virtual room environment.

Furthermore, if the selected product icon is a safe, the mobile communication terminal carries out the method which may include, but is not limited to, a step wherein the screen to purchase the points related with the safe is displayed; and a step wherein if the exit button is clicked, the image object of the virtual room environment is displayed, and the screen returns back to the virtual room environment.

Preferably, if the selected product icon is a window, the mobile communication terminal carries out the method which may include, but is not limited to, a step wherein an audition list button related with the window, an audition registration button, an audition deletion button and an exit button display object are displayed; a step wherein if the audition list button is clicked, the videos, photos and text lists registered by each individual are displayed by subject, and if all the persons who have entered a little theater and are using a corresponding program click the list, each video, photo and text are viewed, and if a predetermined button is clicked, the image object of the virtual room environment is displayed, and the screen returns back to the virtual room environment; a step wherein if the audition registration button is clicked, each individual is able to register the videos, photos and texts showing their talents, and if a predetermined button is clicked, the image object of the virtual room environment is displayed, and the screen returns back to the virtual room environment; and a step wherein if the audition deletion button is clicked, only the person who has registered the material is allowed to delete the material based on the audition registration information, and if a predetermined button is clicked, the image object of the virtual room environment is displayed, and the screen returns back to the virtual room environment.

Moreover, if the selected product icon is a gate, the mobile communication terminal carries out the method comprising a step wherein the app is closed, and the user goes out of the program.

Preferably, if the selected product icon is a game, the mobile communication terminal carries out the method which may include, but is not limited to, a step wherein the game list related with the game is displayed at the screen; a step wherein a desired game is selected from the game list and is executed; and a step wherein if a predetermined button is clicked, the image object of the virtual room environment is displayed, and the screen returns back to the virtual room environment.

Moreover, if the selected product icon is a market, the mobile communication terminal carries out the method which may include, but is not limited to, a step wherein an item purchase button related with the market, and a brand product button display object are displayed at the screen; a step wherein if the item purchase button is clicked, an item of a basic product shape is purchased by a micro payment and is disposed at a desired position, and if a predetermined button is clicked, the image object of the virtual room environment is displayed, and the screen returns back to the virtual room environment; a step wherein if an advertisement button among the brand product buttons is clicked, an enterprise provision advertisement registered by a contracted brand enterprise is displayed, and if a predetermined button is clicked, the image object of the virtual room environment is displayed, and the screen returns back to the virtual room environment; a step wherein if the item purchase button is clicked among the brand product buttons, an item of a predetermined contracted brand product is purchased and disposed at a desired position, thus decorating the room, and if the item is clicked at the screen, an advertisement information provided by the enterprise is displayed, and if a predetermined button is clicked, the image object of the virtual room environment is displayed, and the screen returns back to the virtual room environment; a step wherein if an actual purchase button is clicked among the brand product buttons, the price of the contracted and registered brand product is displayed, thus allowing the actual purchase of the product, and if a predetermined button is clicked, the image object of the virtual room environment is displayed, and the screen returns back to the virtual room environment; a step wherein if a gifting button is clicked among the brand product buttons, the list of the registered friends is displayed at the screen, and if the send button is clicked, the purchased item or brand product is transmitted to the friend that the user has chosen; and a step wherein if the exit button is clicked, the image object of the virtual room environment is displayed, and the screen returns back to the virtual room environment.

Preferably, if the selected product icon is a calendar, the mobile communication terminal carries out the method which may include, but is not limited to, a step wherein the calendar screen related with the calendar is displayed; and a step wherein if the persons in the room click the date of the calendar, the schedule of the date is displayed, and if the room owner double clicks the date of the calendar, his own schedule can be edited, and if a predetermined button is clicked, the image object of the virtual room environment is displayed, and the screen returns back to the virtual room environment.

Moreover, if the selected product icon is a clock, the mobile communication terminal carries out the method which may include a step wherein the clock screen related with the clock is displayed, thus confirming an actual time, and if a predetermined button is clicked, the image object of the virtual room environment is displayed, and the screen returns back to the virtual room environment.

The present invention is directed to a method wherein a virtual space, which is able to provide the maximized reality, is created similar to a real life in a program space using a 3D technology. In the thusly created space, an individual and many users using this program are able to previously experience, while sharing information, the matters that it is hard to experience in a real life. This method will be directly applied to a real life in the future. Moreover, the marketing manufactured in the form of a conventional enterprise advertisement is provided to customers in various audible and video forms, for example, using a television, a radio, an app program, etc. The customers are forced to hear or see such enterprise advertisements which are provided in various ways. The technology of the present invention may allow the customers to hear and see the aforementioned advertisements and select and acquire only the product advertisements that they want to hear and see the products provided in the program by the enterprises. In this way, the products manufactured by the enterprises having advanced technologies can be provided in a virtual reality space, while accurately acquiring the information that they want to obtain. The customers are able to actually purchase the products. The enterprises that don't have enough capital to do advertise are able to sell their products to the customers, thus enhancing market compatibility.

The advantageous effects of the present invention are not limited to the above-described effects, and various effects may be further provided within a range where a person having ordinary skill in the art can draw from the descriptions below.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating the configuration of a system to which a method for virtually experiencing a real life and acquiring information using an app of a mobile communication terminal is applied according to the present invention;

FIG. 2 is a view illustrating in sequence a start operation of a method for virtually experiencing a real life and acquiring information using an app of a mobile communication terminal according to the present invention;

FIG. 3 is a view illustrating in sequence a method for virtually experiencing a real life (a telephone number book) and acquiring information using an app of a mobile communication terminal;

FIG. 4 is a view illustrating in sequence a method for virtually experiencing a real life (a telephone) and acquiring information using an app of a mobile communication terminal;

FIG. 5 is a view illustrating in sequence a method for virtually experiencing a real life (a television) and acquiring information using an app of a mobile communication terminal;

FIG. 6 is a view illustrating in sequence a method for virtually experiencing a real life (a frame) and acquiring information using an app of a mobile communication terminal;

FIG. 7 is a view illustrating in sequence a method for virtually experiencing a real life (an audio system) and acquiring information using an app of a mobile communication terminal;

FIG. 8 is a view illustrating in sequence a method for virtually experiencing a real life (a safe) and acquiring information using an app of a mobile communication terminal;

FIG. 9 is a view illustrating in sequence a method for virtually experiencing a real life (a window) and acquiring information using an app of a mobile communication terminal;

FIG. 10 is a view illustrating in sequence a method for virtually experiencing a real life (a gate) and acquiring information using an app of a mobile communication terminal;

FIG. 11 is a view illustrating in sequence a method for virtually experiencing a real life (a game) and acquiring information using an app of a mobile communication terminal;

FIG. 12 is a view illustrating in sequence a method for virtually experiencing a real life (a market) and acquiring information using an app of a mobile communication terminal;

FIG. 13 is a view illustrating in sequence a method for virtually experiencing a real life (a calendar) and acquiring information using an app of a mobile communication terminal; and

FIG. 14 is a view illustrating in sequence a method for virtually experiencing a real life (a clock) and acquiring information using an app of a mobile communication terminal.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

FIG. 1 is a view illustrating the configuration of a system to which a method for virtually experiencing a real life and acquiring information using an app of a mobile communication terminal is applied according to the present invention.

Referring to FIG. 1, the system according to the present invention may include, but is not limited to, a first mobile communication terminal 101 which belongs to a room owner, and a second mobile communication terminal 102 which may belong to a friend or a text exchange opponent.

The first mobile communication terminal 101 is equipped with an app for virtually experiencing a real life and acquiring information according to the present invention.

The first mobile communication terminal 101 is able to display an image object of a virtual room environment wherein various product icons similar to an actual room environment are disposed at basic positions when a designated app is executed in response to a user's key operation. The first communication terminal 101 will select a predetermined product icon in the virtual room in response to a user's key operation. The first mobile communication terminal 101 may be set mapped by product icon with various function display objects related with a corresponding product, wherein a predetermined function of the mobile communication terminal can be executed when a corresponding function button is clicked. The first mobile communication terminal 101 may allow various function button display objects mapped with the selected product icons to be displayed when the product icons are selected, and a predetermined function of the mobile communication terminal which is set mapped with the selected function button can be executed when the predetermined function button is selected.

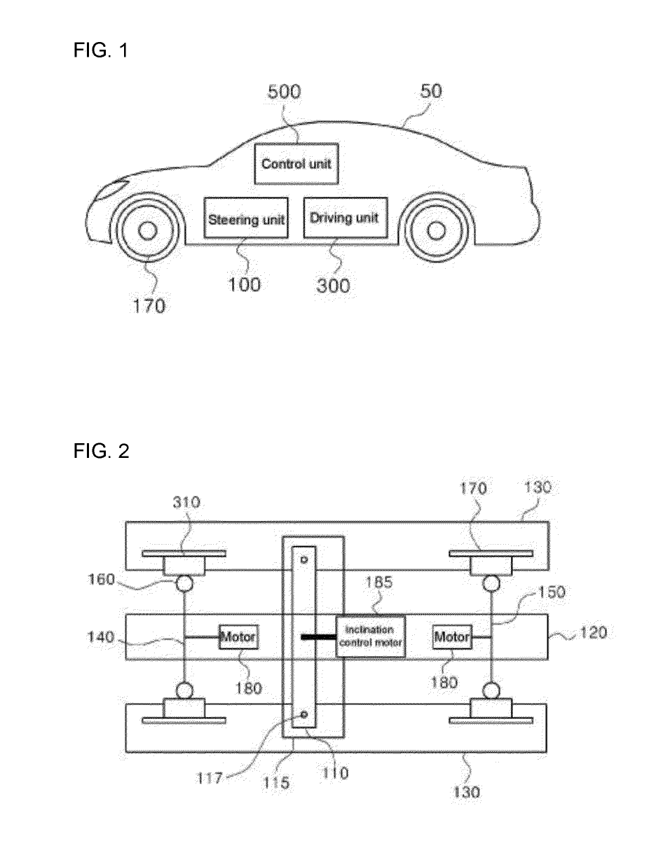

FIGS. 2 to 14 are views illustrating in sequence the method for virtually experiencing a real life and acquiring information using an app of a mobile communication terminal according to the present invention.

The operation of the system to which the method for virtually experiencing a real life and acquiring information using an app of a mobile communication terminal in FIG. 1 according to the present invention is applied will be described with reference to FIGS. 2 to 14.

As illustrated in FIG. 2, the first mobile communication terminal may display an image object of a virtual room environment wherein various product icons similar to an actual room environment are disposed at basic positions when a designated app is executed in response to a user's key operation.

If the item “a basic room” is selected, the image object of the virtual room environment corresponding thereto is displayed. If the item “a move” is selected, a 3D pastoral life house, an apartment and an office hotel are displayed by area, floor, etc., and a basic room may be changed with a micro payment (a point payment), and a previously purchased product may be brought in and may be redisposed in a selected room, and an unnecessary item may be discarded.

If the item “a basic room” is selected, an image object of a virtual room environment may be displayed, wherein the icons showing a telephone number book, a telephone, a television, a frame, a safe, a window, a calendar, a clock, an audio system, a gate, and a market (this button can be activated by only the owner of a room) are disposed at the basic positions of a 3D white quadrangular room.

Moreover, 2D and 3D buttons are disposed at the upper side of the screen. The screen may be converted into the 2D or 3D screen when using the program.

If the 2D screen is selected, the whole configuration of the room can be viewed. In order to view a detailed portion of the room, the screen may be converted into a 3D screen, and any movements are available by dragging the 3D screen. Only the owner of the room is authorized to drag and dispose a predetermined 3D thing (the owner is able to decorate his own room based on the micro payment for a desired item by clicking the market button).

When the image object of the virtual room environment is displayed, a predetermined product icon in the virtual room is selected in response to a user's key operation.

Moreover, the first mobile communication terminal is set mapped with various function button display objects related with a corresponding product by product icon in order for a predetermined function of the mobile communication terminal to be executed when a corresponding button is clicked. The first mobile communication terminal is set for various function button display objects mapped with the selected product icon to be displayed when a product icon is selected, and if a predetermined function button is selected, a predetermined function of the mobile communication terminal set mapped with the selected function button will be executed.

The detailed operation will be described below.

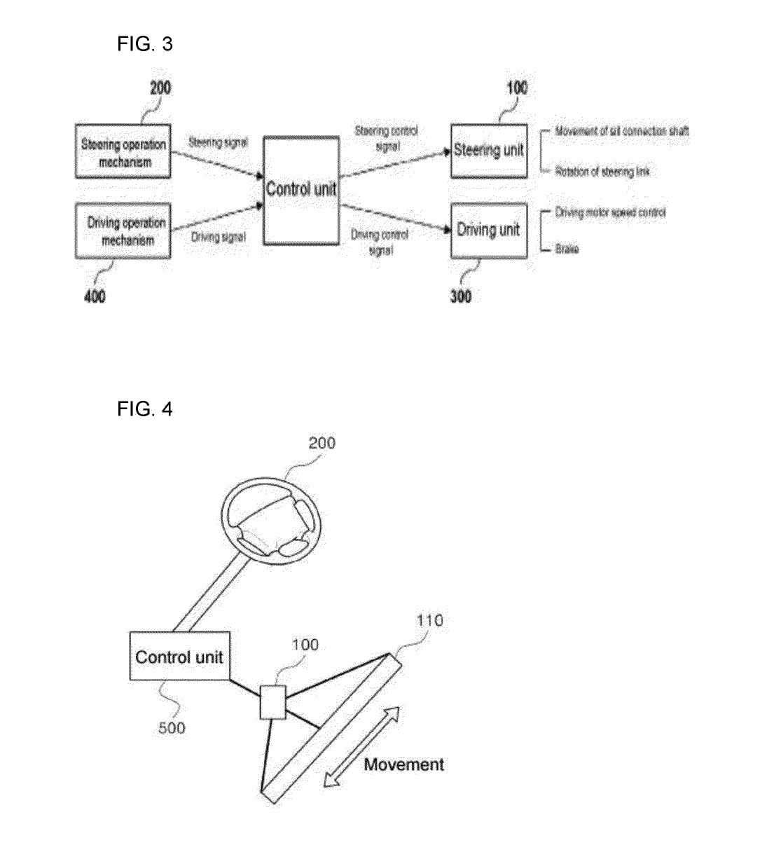

(1) FIG. 3—the Telephone Number Book

If the selected product icon is a telephone number book, the first mobile communication terminal will display the display objects, for example, a friend registration button related with the telephone number book, an invitation button, an invitation request button, a friend deletion button, and an exit button.

If the friend registration button is clicked, the friend names registered in the telephone number book of the first mobile communication terminal are displayed, and the friend who the user wants to register is clicked and registered.

If the invitation request button is clicked, an invitation request is asked for the desired friend to be clicked based on the friend registration information and to enter the friend room. As the invitation request is asked, an approval and rejection popup window is displayed at the screen of the mobile communication terminal. If the opponent clicks the approval button, the image object of the virtual room environment is displayed, and the screen will return back to the virtual room environment, and if the opponent clicks the rejection, the app will end.

Moreover, if the friend deletion button is clicked, a registered friend name list is generated and displayed, and if the friend who the user wants to delete is clicked, the friend will be deleted.

Furthermore, if the exit button is clicked, the image object of the virtual room environment will be displayed, and the screen will return back to the virtual room environment.

(2) FIG. 4—the Telephone

If the selected product icon is a telephone, the first mobile communication terminal will display the text input window related with the telephone.

Moreover, the notice icons corresponding to the texts inputted at the text input window will be displayed on all the mobile communication terminals of the users who are in the same room.

If the notice icon is clicked or the telephone in the room is clicked, the texts will be displayed and confirmed. The texts will be inputted by displaying the text input window.

Furthermore, if the exit button is clicked, the image object of the virtual room environment will be displayed, and the screen will return back to the virtual room environment.

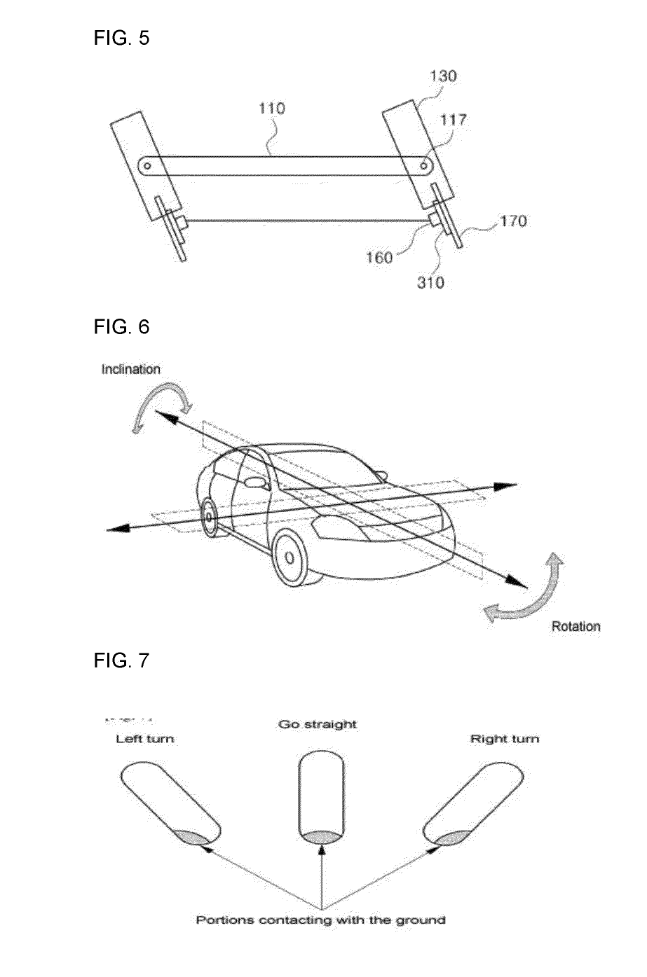

(3) FIG. 5—the Television

If the selected product icon is a television, the first mobile communication terminal will display an image list button related with the television, an image registration button, an image deletion button, and an exit button display object.

Moreover, if the image list button is clicked, the image list registered by the room owner will be displayed at the screen, and if all the persons who have entered the room clicks the list, a video will be played. If a predetermined button is clicked, the image object of the virtual room environment will be displayed, and the screen will change to the virtual room environment.

Moreover, if the image registration button is clicked, the video selected by the room owner among the videos stored in the mobile communication terminal will be registered, and if a predetermined button is clicked, the image object of the virtual room environment will be displayed, and the screen will return back to the virtual room environment.

Furthermore, if the image deletion button is clicked, the video that the room owner wants to delete will be deleted based on the video registration information, and if a predetermined button is clicked, the image object of the virtual room environment will be displayed, and the screen will return back to the virtual room environment.

If the exit button is clicked, the image object of the virtual room environment will be displayed, and the screen will return back to the virtual room environment.

(4) FIG. 6—the Frame

If the selected product icon is a frame, the first mobile communication terminal will display a photo list button related with the frame, a photo registration button, a photo deletion button, and an exit button display object.

Moreover, if the photo list button is clicked, the photo list that the room owner has registered will be displayed at the screen, and if all the persons who have entered the room clicks the list, the image will be displayed, and if a predetermined button is clicked, the image object of the virtual room environment will be displayed, and the screen will return back to the virtual room environment.

Furthermore, if the photo registration button is clicked, the photo selected by the room owner among the photos stored in the first mobile communication terminal will be registered, and if a predetermine button is clicked, the image object of the virtual room environment will be displayed, and the screen will return back to the virtual room environment.

Moreover, if the photo deletion button is clicked, the photo that the room owner wants to delete will be deleted based on the photo registration information, and if a predetermined button is clicked, the image object of the virtual room environment will be displayed, and the screen will return back to the virtual room environment.

In addition, if the exit button is clicked, the image object of the virtual room environment will be described, and the screen will return back to the virtual room environment.

FIG. 7—the Audio System

If the selected product icon is an audio system, the first mobile communication terminal will display a music list button related with the audio system, a music registration button, a music deletion button, and an exit button display object.

Moreover, if the music list button is clicked, a music list that the room owner has registered will be displayed at the screen, and if all the persons who have entered the room clicks the list, a music will be played, and if a predetermined button is clicked, the image object of the virtual room environment will be displayed, and the screen will return back to the virtual room environment.

Moreover, if the music registration button is clicked, the music selected by the room owner among the music stored in the first mobile communication terminal will be registered, and if a predetermined button is clicked, the image object of the virtual room environment will be displayed, and the screen will return back to the virtual room environment.

Furthermore, if the music deletion button is clicked, the music that the room owner wants to play will be deleted based on the music registration information, and if a predetermined button is clicked, the image object of the virtual room environment will be displayed, and the screen will return back to the virtual room environment.

If the exit button is clicked, the image object of the virtual room environment will be displayed, and the screen will return back to the virtual room environment.

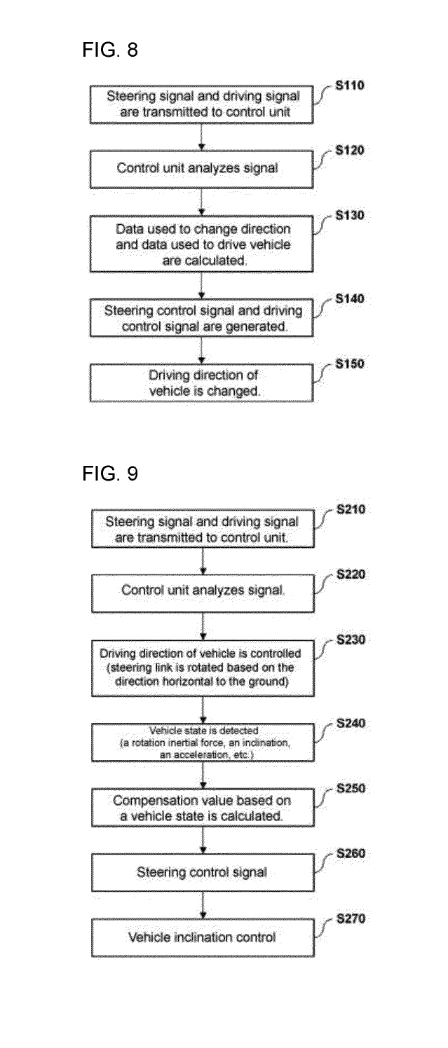

(6) FIG. 8—the Safe

If the selected product icon is a safe, the first mobile communication terminal will display a screen wherein the points related with the safe can be purchased, will be displayed.

Moreover, if the exit button is clicked, the image object of the virtual room environment will be displayed, and the screen will return back to the virtual room environment.

(7) FIG. 9—the Window

If the selected product icon is a window, the first mobile communication terminal will display an audition list button related with the window, an audition registration button, an audition deletion button, and an exit button display object.

Moreover, if the audition list button is clicked, a video, a photo, a text list, etc. that each individual has registered will be displayed by subject, and if the persons who have entered a little theater (the window screen converts into a little theater screen) among all the persons (all the persons who are simultaneously connected using the app of the present invention and are using the window) who are using a corresponding program click the list, each video, photo, texts, etc. are allowed to be viewed, and if a predetermined button is clicked, the image object of the virtual room environment will be displayed, and the screen will return back to the virtual room environment.

Moreover, if the audition registration button is clicked, individuals are allowed to register videos, photos, texts, etc. which are showing their talents, and if a predetermined button is clicked, the image object of the virtual room environment will be displayed, and the screen will return back to the virtual room environment.

Furthermore, if the audition deletion button is clicked, only the person who has registered the material is allowed to delete the material based on the audition registration information, and if a predetermined button is clicked, the image object of the virtual room environment will be displayed, and the screen will return back to the virtual room environment.

(8) FIG. 10—the Gate

If the selected product icon is a gate, the first mobile communication terminal will end the app and go out of the program.

(9) FIG. 11—the Game

If the selected product icon is a game, the first mobile communication terminal will display at the screen the game list which is related with the game.

Moreover, the desired game will be selected from the game list and will be executed.

Furthermore, if a predetermined button is clicked, the image object of the virtual room environment will be displayed, and the screen will return back to the virtual room environment.

(10) FIG. 12—the Market

If the selected product icon is a market, the first mobile communication terminal will display the item purchase button related with the market, and the brand product button display object.

Moreover, if the item purchase button is clicked, an item having a basic product shape among various items being provided by category (as an example, products or as another example, the app itself may provide item information by category) is purchased using the micro payment after the user is connected to the server and is disposed at a desired position, and if a predetermined button is clicked, the image object of the virtual room environment will be displayed, and the screen will return back to the virtual room environment.

If the points are used when purchasing the items, for example, if the user presses the purchase button after suggesting the point price at the server during the purchase of the item, the points will be automatically subtracted from the “Safe” in FIG. 8, thus finishing the purchase.

If the advertisement button is clicked among the brand product buttons, an enterprise provision advertisement that the contracted brand enterprise has registered will be displayed, and if a predetermined button is clicked, the image object of the virtual room environment will be displayed, and the screen will return back to the virtual room environment.

If the item purchase button is clicked among the brand product buttons, an item of a predetermined contracted brand product being provided by category (as an example, products or as another example, the app itself may provide item information by category) is purchased and disposed at a desired position, thus decorating the room. If the points are used when purchasing the items, for example, if the user presses the purchase button after suggesting the point price at the server during the purchase of the item, the points will be automatically subtracted from the “Safe” in FIG. 8, thus finishing the purchase. If the item is clicked at the screen, the advertisement information provided by the enterprises will be displayed, and if a predetermined display object is clicked, the image object of the virtual room environment will be displayed, and the screen will return back to the virtual room environment.

If the actual purchase button is clicked among the brand product buttons, the price of the contracted and registered brand product will be displayed, thus actually purchasing the product. If a predetermined button is clicked, the image object of the virtual room environment will be displayed, and the screen will return back to the virtual room environment.

Moreover, if the gifting button is clicked among the brand product buttons, the list of the registered friends will be displayed at the screen, and if the send button is clicked, the purchased item or brand product will be transmitted to the friend selected by the user (for example, a friend's terminal).

If the exit button is clicked, the image object of the virtual room environment will be displayed, and the screen will return back to the virtual room environment.

(11) FIG. 13—the Calendar

If the selected product icon is a calendar, the first mobile communication terminal will display the calendar screen related with the calendar.

If the persons in the room click the date of the calendar, the schedule of the date will be displayed, and the owner of the room double clicks the date of the calendar, the owner of the room is allowed to edit the date. If a predetermined button is clicked, the image object of the virtual room environment will be displayed, and the screen will return back to the virtual room environment.

(12) FIG. 14—the Clock

If the selected product icon is a clock, the first mobile communication terminal will display the clock screen related with the clock, thus confirming an actual time, and a predetermined button is clicked, the image object of the virtual room environment will be displayed, and the screen will return back to the virtual room environment.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for virtually experiencing real life and acquiring information using an app of a mobile communication terminal, comprising:
a step wherein when a mobile communication terminal executes an app selected by a user's key operation, an image object of a virtual environment is displayed, wherein various product icons corresponding to an actual room environment are disposed at a basic position;
a step wherein the mobile communication terminal selects a predetermined product icon in a virtual room based on a user's key operation; and
a step wherein the mobile communication terminal is mapped by product icon with various function button display objects related with a corresponding product in order for a predetermined function of the mobile communication terminal to be executed when a corresponding function button is clicked, and the mobile communication terminal allows the various function button objects mapped with the selected product icon when the product ion is selected, to be displayed, and when the predetermined function button display object is selected, a predetermined function of the mobile communication terminal which has been set mapped with the corresponding function button is executed,
wherein if the selected product icon is a telephone, the mobile communication terminal carries out the method comprising:
a step wherein a text input window related with the telephone is displayed;
a step wherein a notice icon with respect to the text inputted at the text input window is displayed at the screens of the mobile communication terminals of all persons in a room;
a step wherein if the notice icon is clicked or the telephone in the room is clicked, the texts are displayed and confirmed, and the texts can be inputted by displaying the text input window; and
a step wherein if an exit button is clicked, an image object of the virtual room environment is displayed, and the screen returns back to the virtual room environment.

2. The method of claim 1, wherein if the selected product icon is a telephone number book, the mobile communication terminal carries out the method comprising:
a step wherein the display objects of a friend registration button related with the telephone number book, an invitation button, an invitation request button, a friend deletion button, and an exit button are displayed at the screen;
a step wherein if the friend registration button is clicked, the friend names registered at the telephone number book of the mobile communication terminal are displayed, and a friend who the user wants to register can be clicked and registered;
a step wherein if the invitation request button is clicked, an invitation is requested by clicking a desired friend based on a friend registration information in order to enter a friend's room, and an approval and rejection popup window is displayed at the screen of the opponent's mobile communication terminal in response to the invitation request, and if the opponent clicks the approval, the image object of the virtual room environment is displayed, and the screen returns back to the virtual room environment, and if the opponent clicks the rejection, the app is closed;
a step wherein if the friend deletion button is clicked, a registered friend name is created and displayed, and if the friend who the user wants to delete is selected, the friend is deleted; and
a step wherein if the exit button is clicked, the image object of the virtual room environment is displayed, and the screen returns back to the virtual room environment.

3. The method of claim 1, wherein if the selected product icon is a television, the mobile communication terminal carries out the method comprising:
a step wherein an image list button related with the television, an image registration button, an image deletion button and an exit button display object are displayed;
a step wherein if the image list button is clicked, the image list registered by a room owner is displayed at the screen, and if all the persons who have entered the room click the list, a video is displayed, and if a predetermined button is clicked, the image object of the virtual room environment is displayed, and the screen returns back to the virtual room environment;
a step wherein if the image registration button is clicked, a video selected by the room owner among the videos stored in the mobile communication terminal is registered, and if a predetermined button is clicked, the image object of the virtual room environment is displayed, and the screen returns back to the virtual room environment;
a step wherein if the image deletion button is clicked, a video that the room owner wants to delete is deleted based on the video registration information, and if a predetermined button is clicked, the image object of the virtual room environment is displayed, and the screen returns back to the virtual room environment; and
a step wherein if the exit button is clicked, the image object of the virtual room environment is displayed, and the screen returns back to the virtual room environment.

4. The method of claim 1, wherein if the selected product icon is a frame, the mobile communication terminal carries out the method comprising:
a step wherein if the selected product icon is a frame, the mobile communication terminal displays a photo list button related with the frame, a photo registration button, a photo deletion button, and an exit button display object;
a step wherein if the photo list button is clicked, the photo list registered by the room owner is displayed at the screen, and if all the persons who have entered the room click the list, the image is displayed, and if a predetermined button is clicked, the image object of the virtual room environment is displayed, and the screen returns back to the virtual room environment;
a step wherein if the photo registration button is clicked, the photo selected by the room owner among the photos stored in the mobile communication terminal is registered, and if a predetermined button is clicked, the image object of the virtual room environment is displayed, and the screen returns back to the virtual room environment;
a step wherein if the photo deletion button is clicked, the photo that the room owner wants to delete is deleted based on the photo registration information, and if a predetermined button is clicked, the image object of the virtual room environment is displayed, and the screen returns back to the virtual room environment; and
a step wherein if the exit button is clicked, the image object of the virtual room environment is displayed, and the screen returns back to the virtual room environment.

5. The method of claim 1, wherein if the selected product icon is an audio system, the mobile communication terminal carries out the method comprising:
a step wherein a music list button related with the audio system, a music registration button, a music deletion button and an exit button display object are displayed;
a step wherein if the music list button is clicked, the music list registered by the room owner is displayed at the screen, and if all the person who have entered the room click the list, the music is played, and if a predetermined button is clicked, the image object of the virtual room environment is displayed, and the screen returns back to the virtual room environment;
a step wherein if the music registration button is clicked, the music selected by the room owner among the music stored in the mobile communication terminal is registered, and if a predetermined button is clicked, the image object of the virtual room environment is displayed, and the screen returns back to the virtual room environment;
a step wherein if the music deletion button is clicked, the music that the room owner wants to delete is deleted based on the music registration information, and if a predetermined button is clicked, the image object of the virtual room environment is displayed, and the screen returns back to the virtual room environment; and
a step wherein if the exit button is clicked, the image object of the virtual room environment is displayed, and the screen returns back to the virtual room environment.

6. The method of claim 1, wherein if the selected product icon is a safe, the mobile communication terminal carries out the method comprising:
a step wherein the screen to purchase the points related with the safe is displayed; and
a step wherein if the exit button is clicked, the image object of the virtual room environment is displayed, and the screen returns back to the virtual room environment.

7. The method of claim 1, wherein if the selected product icon is a window, the mobile communication terminal carries out the method comprising:
a step wherein an audition list button related with the window, an audition registration button, an audition deletion button and an exit button display object are displayed;
a step wherein if the audition list button is clicked, the videos, photos and text lists registered by each individual are displayed by subject, and if all the persons who have entered a little theater and are using a corresponding program click the list, each video, photo and text are viewed, and if a predetermined button is clicked, the image object of the virtual room environment is displayed, and the screen returns back to the virtual room environment;
a step wherein if the audition registration button is clicked, each individual is able to register the videos, photos and texts showing their talents, and if a predetermined button is clicked, the image object of the virtual room environment is displayed, and the screen returns back to the virtual room environment; and
a step wherein if the audition deletion button is clicked, only the person who has registered the material is allowed to delete the material based on the audition registration information, and if a predetermined button is clicked, the image object of the virtual room environment is displayed, and the screen returns back to the virtual room environment.

8. The method of claim 1, wherein if the selected product icon is a gate, the mobile communication terminal carries out the method comprising a step wherein the app is closed, and the user goes out of the program.

9. The method of claim 1, wherein if the selected product icon is a game, the mobile communication terminal carries out the method comprising:
a step wherein the game list related with the game is displayed at the screen;
a step wherein a desired game is selected from the game list and is executed; and
a step wherein if a predetermined button is clicked, the image object of the virtual room environment is displayed, and the screen returns back to the virtual room environment.

10. The method of claim 1, wherein if the selected product icon is a market, the mobile communication terminal carries out the method comprising:
a step wherein an item purchase button related with the market, and a brand product button display object are displayed at the screen;
a step wherein if the item purchase button is clicked, an item of a basic product shape is purchased by a micro payment and is disposed at a desired position, and if a predetermined button is clicked, the image object of the virtual room environment is displayed, and the screen returns back to the virtual room environment;
a step wherein if an advertisement button among the brand product buttons is clicked, an enterprise provision advertisement registered by a contracted brand enterprise is displayed, and if a predetermined button is clicked, the image object of the virtual room environment is displayed, and the screen returns back to the virtual room environment;
a step wherein if the item purchase button is clicked among the brand product buttons, an item of a predetermined contracted brand product is purchased and disposed at a desired position, thus decorating the room, and if the item is clicked at the screen, an advertisement information provided by the enterprise is displayed, and if a predetermined button is clicked, the image object of the virtual room environment is displayed, and the screen returns back to the virtual room environment;
a step wherein if an actual purchase button is clicked among the brand product buttons, the price of the contracted and registered brand product is displayed, thus allowing the actual purchase of the product, and if a predetermined button is clicked, the image object of the virtual room environment is displayed, and the screen returns back to the virtual room environment;
a step wherein if a gifting button is clicked among the brand product buttons, the list of the registered friends is displayed at the screen, and if the send button is clicked, the purchased item or brand product is transmitted to the friend that the user has chosen; and
a step wherein if the exit button is clicked, the image object of the virtual room environment is displayed, and the screen returns back to the virtual room environment.

11. The method of claim 1, wherein if the selected product icon is a calendar, the mobile communication terminal carries out the method comprising:
a step wherein the calendar screen related with the calendar is displayed; and
a step wherein if the persons in the room click the date of the calendar, the schedule of the date is displayed, and if the room owner double clicks the date of the calendar, his own schedule can be edited, and if a predetermined button is clicked, the image object of the virtual room environment is displayed, and the screen returns back to the virtual room environment.

12. The method of claim 1, wherein if the selected product icon is a clock, the mobile communication terminal carries out the method comprising a step wherein the clock screen related with the clock is displayed, thus confirming an actual time, and if a predetermined button is clicked, the image object of the virtual room environment is displayed, and the screen returns back to the virtual room environment.
